(19) United States
(12) Patent Application Publication
(10) Pub. No.: US 2008/0169592 A1
(43) Pub. Date: Jul. 17, 2008

(54) Antivibration Support

(75) Inventor: Blake Adams, Comstock Park, MI (US)

Correspondence Address: MILLER, MATTHIAS & HULL, ONE NORTH FRANKLIN STREET, SUITE 2350, CHICAGO, IL, 60606, US

(73) Assignee: PAULSTRA CRC, Grand Rapids, MI (US)

(21) Appl. No.: 11/622,274

(22) Filed: Jan. 11, 2007

(51) Int. Cl. F16F 15/00

(52) U.S. Cl. 267/140.13

(57) ABSTRACT

An antivibration support disposed for supporting and dampening loads between external elements, comprising a first and a second rigid member for securing to the external elements, and an elastomer body, connecting respectively the first and second rigid members.

The support also comprises a second body, having dissimilar material properties from the elastomer body, acting in parallel with the elastomer body to support and dampen the loads.

### FIELD OF THE INVENTION

The invention relates to antivibration supports.

### BACKGROUND OF THE INVENTION

More precisely, the invention relates to an antivibration support disposed for supporting and dampening static and dynamic loads between a first and a second rigid element, comprising:
a first rigid member, for securing to said first rigid element;
a second rigid member, for securing to said second rigid element; and
a first body, connected respectively to said first and said second rigid members, said first body being disposed to support said static loads and dampen said dynamic loads

With such supports, it is usually desirable to minimize the dynamic stiffness for better acoustic performance (low vibrational amplitudes and high frequencies), and to have high stiffness in static and high-amplitude events to control large motion.

Generally, a hard material is used in order to control large motion, resulting in a high dynamic stiffness and poor acoustic performance. Due to material properties, it is possible to somewhat offset a high dynamic stiffness by using a softer material having a large cross-section. This way, high amplitude/low frequency conditions will exhibit relatively high stiffness, and low amplitude/high frequency conditions will exhibit relatively low stiffness.

Unfortunately, space limitations in the vehicle often make this alternative impractical.

### OBJECTS AND SUMMARY OF THE INVENTION

One objective of the present invention is to mitigate these drawbacks.

To this end, according to a first aspect of the invention, in a support of the type in question, a second body acts in parallel with said first body to support and dampen said loads; and the said first body and said second body have dissimilar material properties.

By means of these dispositions, one can utilize a second material having complementary qualities to those exhibited by the first body (also known as the elastomer body). Such complementary qualities may be demonstrated especially in improved dynamic stiffness (harder material maintains low damping, thus low dynamic stiffness).

According to a second aspect of the invention, in a support of the type in question, a second body acts in parallel with said first body to support and dampen said loads; and the first rigid member, second rigid member, and first body define a receiving portion for receiving said second body, and axe designed for enabling the mounting of said second body on said antivibration support.

By means of these dispositions, it becomes possible to bring modifications to an exisiting support by simply and easily mounting the second body.

A further benefit of any of these dispositions is improved thermal resistance of the support owing to the second material protecting the first body.

In various embodiments of the invention, one may additionally have recourse to any one or more of the following provisions:
the first body is made of elastomer;
the second body is made of silicone;
the first body has a substantially frusto-conical shape, partially defining a working chamber, and further comprising a flexible wall and a rigid partition, said flexible wall partially defining a compensation chamber and together with the first body sealingly defining an enclosed volume of liquid, said rigid partition dividing said compensation chamber to said working chamber;
the first body and the second body are concentric;
the second body covers a large proportion of the first body;
the first body and the second body are bonded to each other;
the first body and the second body have lubricating material therebetween;
an air gap is provided between the first body and the second body;
the support further comprises fixation means for constraining said second body to act in parallel with said first body;
the fixation means clamps the second body against the first body;
the fixation means stops the second body in a longitudinal direction relative to the first body;
the second body is cylindrical, and supports the loads radially;
the first body forms an inverted V with two diverging branches, the second body being positioned between said two diverging branches of the first body; and
the second body is tubular.

### BRIEF DESCRIPTION OF THE DRAWINGS

Other features and advantages of the invention appear from the following detailed description of one of its embodiments, given by way of non-limiting example, and with reference to the accompanying figures, in which:

FIG. 1 is a longitudinal axial cross section of a first embodiment of the present invention;

FIG. 2 is a longitudinal axial cross section of a first variant of the first embodiment;

FIG. 3 is a longitudinal axial cross section of a second variant of the first embodiment; and

FIG. 4 is a lateral cross section of a second embodiment of an antivibration support formed according to the present invention.

### DETAILED DESCRIPTION OF THE INVENTION

In the figures, the same references denote identical or similar features.

Also, in the following description, terms such as “up”, “top”, “down”, “bottom”, “base”, “vertical”, “horizontal”, are used to make the description simpler and clearer, and they refer to the normal positional of views of the devices of the invention, but such terms are in no way limitating.

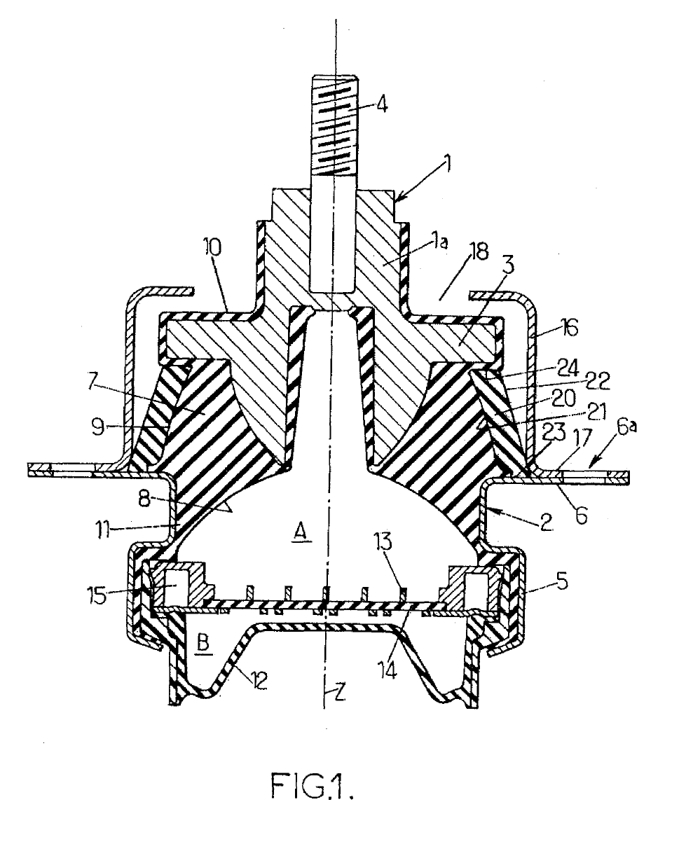

The hydraulic antivibration device according to a first embodiment of the present invention, and as illustrated in FIG. 1 by way of example, comprises a first rigid strength member 1 and a second rigid strength member 2, extending along a substantially vertical longitudinal axis Z. Both first and second rigid strength members 1, 2 are predisposed to be interposed and attached between external rigid elements for support and dampening. These external rigid elements may for example be a vehicle chassis and an engine (not shown).

The first rigid strength member 1 comprises a substantially cylindrical body 1a, extending along axis Z. The first rigid strength member further comprises a collar 3 extending outwardly from the cylindrical body 1a, and an upwardly extending stud 4 disposed for fixing, for example, to the engine. The stud 4 may extend upwardly with a slight incline with respect to the vertical axis Z.

The second rigid strength member 2 takes the form of an annular wall extending substantially vertically along vertical axis Z between a vertically extending base portion 5 and a folded back, horizontally extending top portion 6 The top portion 6 of the second rigid strength member 2 is further disposed with a plurality of attachment points 6a for fixing, for example, to a vehicle chassis.

A first body 7, also referred to as an elastomer body, is disposed between, and connects together, the first and second rigid members 1, 2 by adhesion or by overmolding during the manufacturing process.

The elastomer body 7 extends in a substantially frusto-conical ox bell-shaped form about the vertical axis Z, between an inside surface 8 and an outside surface 9. It further extends along the vertical axis Z between a top 10 which is overmolded on the collar 3 of the first rigid strength member 1, and an annular base 11 which is adhered to an inwardly protruding section of the second rigid strength member 2

The elastomer body 7 presents sufficient compression strength to be able to support the static forces of the supportable external bodies, in a vertical direction parallel to the vertical axis Z. It can further dampen relative vibration between the first and second rigid member 1, 2, at least about the vertical axis Z.

The elastomer body 7, is typically made of an elastomer such as Vegaprene®, natural rubber, synthetic elastomer, a thermoplastic elastomer, or similar It exhibits, in and of itself, a first inherent resiliency and dynamic stiffness coefficient, which is specific to the material used.

A flexible wall 12 is sealingly positioned against the base portion 5 of the second rigid member 2 so as to define, together with the elastomer body 7, a sealed volume filled with fluid.

The flexible wall 12 is made from a deformable and preferably resilient material. It may for example be in elastomer reinforced or not by an appropriate fabric. The elastomer material of the flexible wall may for instance be Vegaprene®, natural rubber, synthetic material or a thermoplastic elastomer.

A rigid partition 13 divides the sealed volume into two chambers, namely a working chamber A on the elastomer body 7 side, and a compensation chamber B on the flexible wall 12 side. This rigid partition 13 further defines a constricted passage 15 along the periphery of this partition 13. The constricted passage 15 allows fluidic communication from the working chamber A to the compensating chamber B. In some instances, the rigid partition 13 may further include a decoupling valve 14 for further filtering vibrations of relatively low amplitude and relatively high frequency, as it is well known in the art. In such cases, and as illustrated, the rigid partition 13 may be constructed from an upper ox a lower perforated plate to enclose and to limit the movements of the decoupling valve 14.

The operation of the antivibration device as described is as follows:
when vibratory axial movements of relatively low frequency, for example, lower than 20 hertz, and relatively high amplitude, for example higher than 1 mm, are applied between the first rigid strength member 1 and the second rigid member 2, the elastomer body 7 flexes, causing the transfer of liquid from the working chamber A into the compensation chamber B, through the constricted passage 15. This movement of liquid damps the vibration applied to the rigid strength members 1, 2, with a particular efficiency in the vicinity of a resonance frequency of the constricted passage 15; and
when vibratory axial movement of relatively high frequency, for example, higher than 20 hertz, and relatively low amplitude, for example lower than 1 mm, are applied between the two rigid strength members 1, 2, these movements are filtered by the decoupling valve 14 as it is well known in the art.

In the illustrated example, the hydraulic antivibration support in question further comprises a rigid case 16 having lower flanges 17 bound to the folded back, horizontally extending top portion 6 of the second rigid member 2, and a top opening 18 for receiving the first rigid member 1 and the stud 4. This case 16, surrounding the elastomer body 7, further surrounds and overlaps the collar 3 of the first rigid member 1 to function as a stop in order to limit the relative movements between the first and second rigid member 1, 2.

As stated earlier, with such supports, it is usually desirable to minimize the dynamic stiffness at low amplitude/high frequency events for better acoustic performance Equally, it is desirable to have a high stiffness in static and high amplitude events to control large motions. Furthermore, due to the sometimes harsh thermal conditions usually found in environments where such antivibration devices are used, it is sometimes equally desirable for the support to have high thermal resistance to extend the working life of the support by preserving the elastomer body.

Constructing the elastomer body 7 out of a silicone material exhibits desirable properties in terms of dynamic stiffness and in thermal resistance, as the harder silicone material maintains a lower damping which in turns leads to low dynamic stiffness.

In fact, silicone at seventy shore hardness A can have a Tangent Delta (damping measurement) as low as 0.1, while natural rubber at this hardness can only be as low as about 0.2, giving silicone the advantage for acoustic performance. Unfortunately, elastomeric bodies (corresponding to the present elastomer body 7) made with silicone often have problems with adhesion and chemical compatibility with the fluid present in the working chamber A.

Therefore, a first object of the present invention is to use a second body 20 acting in parallel with the first body 7 to support and dampen the loads, whereby the first body 7 and a second body 20 have dissimilar material properties in terms of dynamic stiffness or temperature resistance, as is illustrated in FIG. 1.

The second body 20 is substantially frusto-conicaly shaped and has its central axis of symmetry aligned with the central axis Z, and concentrically positioned with and around the elastomer body 7. Of course, the present invention is not limited by a symmetrical second body 20, and may have other non-symmetrical shapes.

The second body 20 presents a second inherent resiliency and dynamic stiffness coefficient. However, these characteristics are primarily exhibited in a longitudinal direction; the lateral stiffness coefficient being negligible, which can be desirable for vibration isolation.

The first resiliency of the elastomer body 7 and the second resiliency of the second body 20 complement each other to give:
a third resiliency and dynamic stiffness coefficient, the third resiliency and dynamic stiffness coefficient being a function of the first and second resiliency and dynamic stiffness;
a vibration spectrum with body resonances placed at desired frequencies, which for example have low sensitivity in a vehicle—the resonance frequencies can be tuned to the desired range by adjusting the mass and stiffness of the two bodies.

The disposition of having the second body acting in parallel with the elastomer body increases the static stiffness of the part while maintaining low damping, thus taking advantage of the low damping properties of silicone with high static stiffness. This effect is maximized by using very soft natural rubber having low damping for the elastomer body element and hard silicone with low damping for the second body

The tubular second body 20 extends radially about the central axis Z between a first interior surface 21 lying flush with the exterior surface 9 of the elastomer body 7, and an exterior surface 22. It further extends along the vertical axis Z from a first bottom extremity 23 to a second top extremity 24 The first bottom extremity 23 abuts the horizontally extending top portion 6 of the second rigid member 2, and the second top extremity abuts against the collar 3 of the first rigid element 1, the collar thus forming a longitudinal stop. The tubular second body 20 is thus constrained from moving vertically between the first rigid member 1 and the second rigid member 2

This invention does not limit itself to this embodiment Indeed, one can conceive different modes of positioning and means of fixing the second body 20, whereby the collar 3 forming a longitudinal stop is but one example.

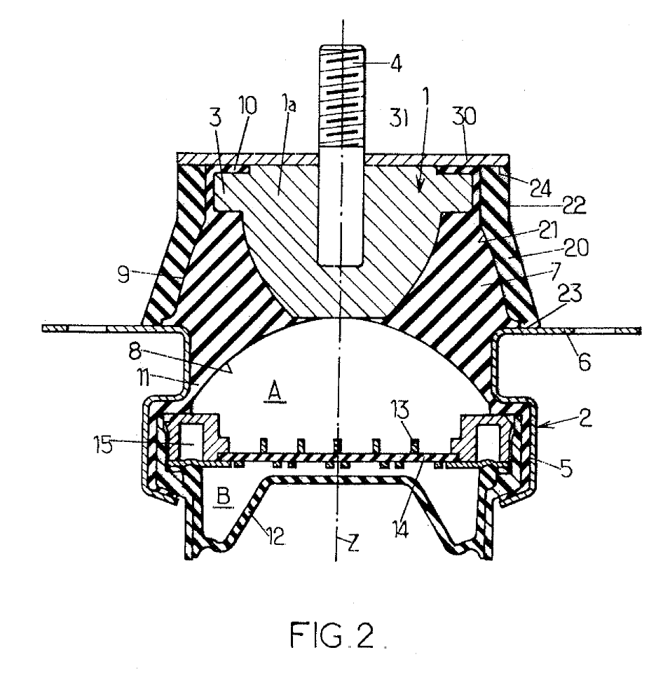

FIG. 2 illustrates a variant of the first embodiment for constraining the second body 20. This variant is similar to the hydraulic antivibration support as represented in FIG. 1 but is illustrated without the rigid case 16 of FIG. 1. However, the hydraulic antivibration support according to this variant further comprises a disk 30 having a central opening 31 to fit around the stud 4, such that the disk 30 is fixed to the upper portion of the first rigid member I The disk 30 may be fixed by adhesion or by other means to the first rigid member 1.

The disk 30 overlaps the elastomer body 7 and extends laterally towards the second body 20 in order to provide longitudinal abutment to the second body 20 in a similar manner as the collar 3 in FIG. 1, to thus constrain the second body to support loads in parallel with the elastomer body 7.

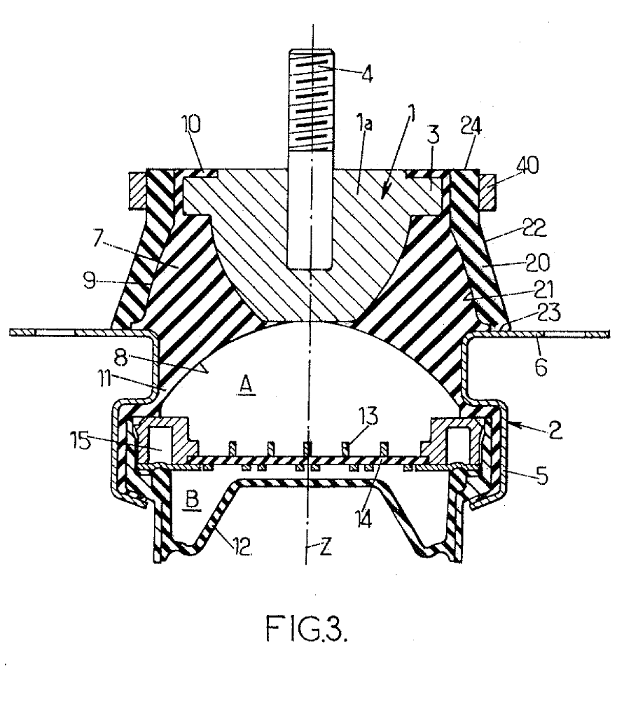

FIG. 3 illustrates yet another alternative means of constraining the second body 30 to the elastomer body 7. In this embodiment, a clamping ring 40 is used to fix the end portion of the second body 20 nearest to the upper extremity 24 to the first rigid member 1 In this embodiment, the second body is thus contrained at its upper portion by the clamping ring 40, and at its lower portion by abutment against the second rigid member 2.

Alternatively to mechanical fixing means, this invention also has recourse for the second body 20 to be adhered directly to the elastomer body and any component, such as the first or second rigid member, the elastomer body, or other parts that it may contact.

In all variants of the first embodiment presented hereabove and illustrated in FIGS. 1 to 3, the second body 20 is thus constrained to move and to absorb the loads in parallel with the elastomer body 7.

In the case the second body is made of silicone, the mechanical fastening means avoids the need for silicone adhesion to another material, which often has problems in durability.

In further alternate embodiments, it may be beneficial for there to be a lubricating material present between the elastomer body 7 and the second body 20 to alter sliding behavior between the two bodies, thereby affecting dynamic characteristics of the mount overall Alternatively, it is envisaged to have a gap between the elastomer body 7 and the second body 20 to eliminate the sliding friction between the surfaces thereof.

The second body 20 is typically made independently from the elastomer body 7, and then fitted to the antivibration support by expanding the second body 20 around the elastomer body 7, then releasing the second body 20 in place. This permits, for example, the modification of an existing support having a certain resiliency and dynamic stiffness to be simply modified by adding a second body 20 in the form of a ring of elastomer material designed to act in parallel with the elastomer body 7.

Alternatively, the second body 20 may be overmolded onto the elastomer body 7. Still alternatively, the elastomer body 7 and the second body 20 may be bi-injection molded together in place.

In the case that the second body 20 is made independently from the antivibration support, the first rigid member 1, the second rigid member 2, and the elastomer body 7 may define a receiving portion for receiving the second body 20.

The second body 20 may therefore be either slipped on, or expanded and released in position, and fastened in placed if required in the receiving portion provided.

These dispositions thus allow for the effective modifications of static and dynamic characteristics without the need to produce a new elastomer body 7, allowing for example a standard antivibration support to be produced in large quantities, and modified without the need for complex tooling.

It offers the possibility of a stiffer variation of an existing support which would otherwise require more expensive tooling to create a second part (for example another complete set of molds to make a new support would be replaced by a simple mold to make just the second body).

A second body made of silicone, in addition to having desirable dynamic properties, also has desirable thermal properties, which in some cases, such as when positioned as shown in FIG. 1, can completely protect the elastomer body from thermal and ozone degradation while itself not undergoing any appreciable degradation, resulting in increased durability and life.

It also has an advantage over an all-silicone elastomer body due to the fact that a rubber elastomer body also prevents any issues which could occur from silicone in contact with a damping fluid

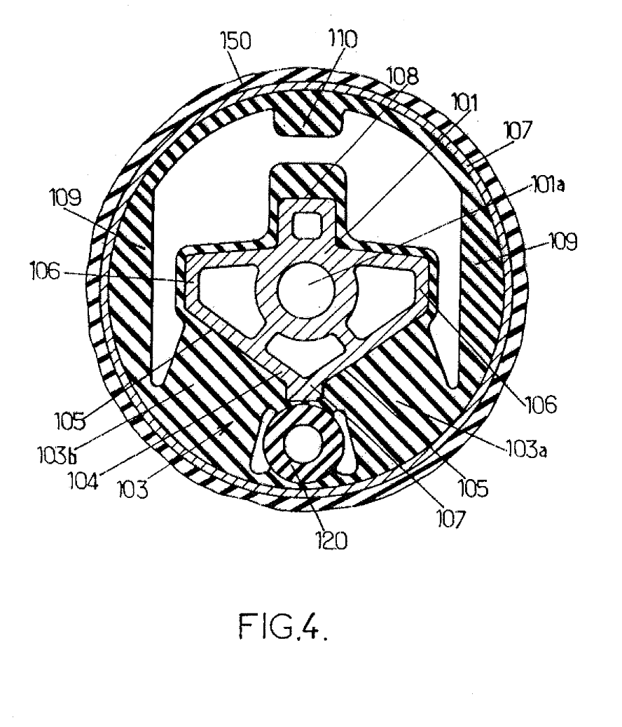

An alternate embodiment of the present invention, relating to a cylindrical antivibration support is illustrated in FIG. 4 and will be described herebelow in more details.

FIG. 4 illustrates a first rigid strength member 101 presenting an opening 101a for attaching to a first external rigid element (not shown), and an outside tubular second rigid strength member 102 pressed inside an opening disposed in a second external rigid element (here represented by a body 150) Both rigid strength members 101, 102 are overmolded by a relatively thin layer of elastomer.

The first rigid strength member 101 is positioned centrally inside the tubular second rigid member 102, and they are resiliently connected together by an elastomer body 103.

The first rigid strength member 101 presents a substantially V-shaped base 104 having two bottom faces 105 converging from two lateral opposed protrusions 106 towards a bottom apex 107 The first rigid strength member 101 further comprises a top protrusion 108 protruding from the top surface of the first rigid strength member 101

The side and top protrusions 106, 107 are positioned and adapted for coming into contact with, respectively, two lateral abutment zones 109, and a top abutment zone 110 disposed on the inside surface of the second rigid strength member 102. These abutment zones are disposed with a greater localized volume of elastomer for limiting movement.

The thickness of the abutment zones 109, 110, and the size of the lateral and top protrusion 106, 108 are designed for limiting radial movements between the first and second rigid strength member 101, 102 when these are submitted to relative vibrations and loads. The distance separating the abutment zones from the protrusions of the first rigid strength member is determined from the amount of relative movement desired.

The elastomer body 103 comprises two branches 103a, 103b diverging from the respective bottom faces 105 of the first rigid strength member 101 towards the second rigid strength member 102.

Furthermore, a tubular second body 120 is disposed between the two diverging branches 112 of the elastomer body 111, and between the apex 107 of the first rigid strength member 101 and the second rigid member 102.

The second body 120 may be tubular (hollow), plain cylindrical, or other shapes to fit the application In the present embodiment, The central axis of the second body 120 lies in the horizontal plane of the support, and is substantially perpendicular to the vertical axis of the support and to the load direction

The second body 120 may be inserted after molding the elastomer body 103, of they may be bi-injection molded together.

The second body 120 is preferably made out of a silicone material chosen to complement the dynamic stiffness characteristics of the elastomeric material constituting the elastomer body 103.

This allows external loads to be damped through not only one material but two complementary materials Thus, each material are specifically chosen to have desirable characteristics for a particular operating mode, and chosen to complement each other.

As a result, dynamic loads acting upon the antivibration support according to the embodiment will be supported by the elastomer body 103 as well as the second body 120, presenting a different response profile than if the elastomer body 103 would be acting alone.

However, it is conceivable to also design a second body 120 in elastomer in order to complement the existing support, for example in cases where an antivibration support already exists. This prevents important modifications to the support, or indeed the manufacture of a new support for the response desired.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the appended claims.

We claim:

1. An antivibration support disposed for supporting and dampening static and dynamic loads between a first and a second rigid element, comprising:
a first rigid member, for securing to said first rigid element;
a second rigid member, for securing to said second rigid element;
a first body, connected respectively to said first and said second rigid members, said first body being disposed to support said static loads and dampen said dynamic loads;
wherein a second body acts in parallel with said first body to support and dampen said loads; and
wherein said first body and said second body have dissimilar material properties.

2. A support according to claim 1, wherein said first body is made of elastomer.

3. A support according to claim 1, wherein said second body is made of silicone.

4. A support according to claim 1, wherein the first body has a substantially frusto-conical shape, partially defining a working chamber, and further comprising a flexible wall and a rigid partition, said flexible wall partially defining a compensation chamber and together with the first body sealingly defining an enclosed volume of liquid, said rigid partition dividing said compensation chamber to said working chamber.

5. A support according to claim 1, wherein the first body and the second body are concentric.

6. A support according to claim 5, wherein the second body covers a large proportion of the first body.

7. A support according to claim 6, wherein the second body surrounds the first body.

8. A support according to claim 1, wherein the first body and the second body are bonded to each other.

9. A support according to claim 1, wherein the first body and the second body have lubricating material therebetween.

10. A support according to claim 1, wherein an air gap is provided between the first body and the second body.

11. A support according to claim 1, wherein the support further comprises fixation means fox constraining said second body to act in parallel with said first body.

12. A support according to claim 11, wherein the fixation means clamps the second body against the first body.

13. A support according to claim 11, wherein the fixation means stops the second body in a longitudinal direction relative to the first body.

14. A support according to claim 1, wherein the second body is cylindrical, and supports the loads radially

15. A support according to claim 14, wherein the first body forms an inverted V with two diverging branches, the second body being positioned between said two diverging branches of the first body.

16. A support according to claim 14, wherein the second body is tubular.

17. A support according to claim 1, wherein the first rigid member, second rigid member, and first body define a receiving portion for receiving said second body, and are designed for enabling the mounting of said second body on said antivibration support.

18. An antivibration support disposed for supporting and dampening static and dynamic loads between a first and a second rigid element, comprising:
a first rigid member, for securing to said first rigid element;
a second rigid member, for securing to said second rigid element;
an first body, connected respectively to said first and said second rigid members, said first body being disposed to support said static loads and dampen said dynamic loads;
wherein a second body acts in parallel with said first body to support and dampen said loads; and
wherein the first rigid member, second rigid member, and first body define a receiving portion for receiving said second body, and are designed fox enabling the mounting of said second body on said antivibration support.

19. A support according to claim 18, wherein the first body has a substantially frusto-conical shape, partially defining a working chamber, and further comprising a flexible wall and a rigid partition, said flexible wall partially defining a compensation chamber and together with the first body sealingly defining an enclosed volume of liquid, said rigid partition dividing said compensation chamber to said working chamber.

20. A support according to claim 18, wherein the first body and the second body are concentric.

21. A support according to claim 20, wherein the second body covers a large proportion of the first body

22. A support according to claim 21, wherein the second body surrounds the first body

23. A support according to claim 18, wherein the first body and the second body are bonded to each other.

24. A support according to claim 18, wherein the first body and the second body have lubricating material therebetween.

25. A support according to claim 18, wherein an air gap is provided between the first body and the second body.

26. A support according to claim 18, wherein the support further comprises fixation means for constraining said second body to act in parallel with said first body.

27. A support according to claim 26, wherein the fixation means clamps the second body against the first body.

28. A support according to claim 26, wherein the fixation means stops the second body in a longitudinal direction relative to the first body.

29. A support according to claim 18, wherein the second body is cylindrical, and supports the loads radially.

30. A support according to claim 29, wherein the first body forms an inverted V with two diverging branches, the second body being positioned between said two diverging branches of the first body.

31. A support according to claim 29, wherein the second body is tubular.

32. A support according to claim 18, wherein said first body and said second body have dissimilar material properties.

33. A support according to claim 32, wherein the first body is made of elastomer, and the second body is made of silicone.
